(19) United States
(12) Patent Application Publication
(10) Pub. No.: US 2015/0022125 A1
(43) Pub. Date: Jan. 22, 2015

(54) ELECTRIC TOOL

(71) Applicant: HITACHI KOKI CO., LTD., Tokyo (JP)

(72) Inventors: Nobuhiro Takano, Ibaraki (JP); Tetsuhiro Harada, Ibaraki (JP); Yoshio Iimura, Ibaraki (JP); Tomomasa Nishikawa, Ibaraki (JP); Hiroki Uchida, Ibaraki (JP); Yoshihiro Nakano, Ibaraki (JP)

(21) Appl. No.: 14/380,251

(22) PCT Filed: Mar. 13, 2013
(86) PCT No.: PCT/JP2013/058176

§ 371 Date: Aug. 21, 2014

(30) Foreign Application Priority Data
Mar. 14, 2012 (JP) 2012-058034

(51) Int. Cl. H02P 6/08

(52) U.S. Cl. CPC H02P 6/08
USPC 318/139

(57) ABSTRACT

An electric tool for driving a tip tool, the electric tool includes: a removable battery; the brushless motor configured to generate a driving force for driving the tip tool; an inverter circuit configured to supply drive power from the removable battery to the brushless motor using a plurality of semiconductor switching elements; a controller configured to control the inverter circuit to control rotation of the brushless motor; a temperature detector configured to detect a temperature of the brushless motor or the semiconductor switching elements; and a voltage detector configured to detect a voltage of the battery. The brushless motor is driven such that a duty ratio of PWM drive signal for driving the semiconductor switching elements is determined based on relationship between the temperature detected by the temperature detector and the voltage detected by the voltage detector.

### TECHNICAL FIELD

The present invention relates to an electric tool and, more particularly, to an electric tool in which a control method of a motor used as a driving source is improved.

### BACKGROUND ART

A handheld electric tool, especially, a cordless electric tool which is driven by the electric energy accumulated in a battery is widely used. In the electric tool where a tip tool such as a drill or a driver is rotationally driven by a motor to perform a required work, the battery is used to drive a brushless DC motor, as disclosed in JP 2008-278633 A, for example. The brushless DC motor refers to a DC (Direct Current) motor which has no brush (brush for rectification). The brushless DC motor employs a coil (winding) at a stator side and a permanent magnet at a rotor side and has a configuration that power driven by an inverter is sequentially energized to a predetermined coil to rotate the rotor. The brushless DC motor has a high efficiency compared to a motor with a brush and can improve a working time per charge in the electric tool using a rechargeable battery. Further, since the brushless DC motor includes a circuit on which a switching element for rotationally driving the motor is mounted, it is easy to achieve an advanced rotation control of the motor by an electronic control.

The brushless DC motor includes the rotor having the permanent magnet, the stator having multiple-phase armature windings (stator windings) such as three-phase windings, position detecting elements constituted by a plurality of Hall ICs which detect a position of the rotor by detecting a magnetic force of the permanent magnet of the rotor and an inverter circuit which drives the rotor by switching a DC voltage supplied from a battery pack, etc., using semiconductor switching elements such as FET (Field Effect Transistor) or IGBT (Insulated Gate Bipolar Transistor) and changing energization to the stator winding of each phase. A plurality of position detecting elements correspond to the multiple-phase armature windings and energization timing of the armature winding of each phase is set on the basis of position detection results of the rotor by each of the position detecting elements.

### SUMMARY

By the way, the stator and the switching element generate heat in accordance with the use of the electric tool, but components of the brushless DC motor have specified operating temperature conditions and therefore it is important to operate the brushless DC motor in the range of the specified operating temperature conditions. In the electric tool, a problem that temperature rise occurs in a motor body or the semiconductor switching elements of a fixed drive circuit in the motor body due to a continuous operation or overload, and thus thermal damage may be caused in these components or elements constituting these components. In order to solve this problem, it is preferable that an operator reduces the rotation number of the motor or stops the motor to cool the motor part before the thermal damage is caused. However, in order to perform such a cooling operation a tightening work or a cutting work is essentially stopped and thus operation efficiency is degraded. In addition, it is difficult for an operator to determine whether abnormal temperature rise occurs in the motor part or not.

One aspect of the present invention has been made to solve the above-described problems and an object of the one aspect of the present invention is to provide an electric tool capable of protecting a motor or a control circuit from thermal damage which may be caused when temperature rise exceeds a predetermined value.

Another object of the present invention is to provide an electric tool which can be continuously operated without stopping the motor by operating the electric tool in a predetermined temperature rise range.

Yet another object of the present invention is to provide an electric tool capable of continuing to perform a high-load work while exchanging a battery.

Representative aspects of the invention disclosed herein are as follows.
(1) An electric tool for driving a tip tool, the electric tool comprising:

a removable battery;

a brushless motor configured to generate a driving force for driving the tip tool;

an inverter circuit configured to supply drive power from the removable battery to the brushless motor using a plurality of semiconductor switching elements;

a controller configured to control the inverter circuit to control rotation of the brushless motor;

a temperature detector configured to detect a temperature of the brushless motor or the semiconductor switching elements; and

a voltage detector configured to detect a voltage of the battery,

wherein the brushless motor is driven such that a duty ratio of PWM drive signal for driving the semiconductor switching elements is determined based on relationship between the temperature detected by the temperature detector and the voltage detected by the voltage detector.
(2) The electric tool according to (1), wherein

the inverter circuit includes a circuit board on which the semiconductor switching elements are mounted,

the circuit board is fixed to an end side of the brushless motor and,

the temperature detector is mounted on the circuit board.
(3) The electric tool according to (1) or (2), wherein the controller controls the inverter circuit to decrease the duty ratio of PWM drive signal when the detected voltage is high and controls the inverter circuit to increase the duty ratio of PWM drive signal as the detected voltage is dropped.
(4) The electric tool according to (3), wherein the controller controls the inverter circuit to restrict an upper limit of the duty ratio to a predetermined value less than 100% immediately after the battery in a state of fully charged is mounted and controls the inverter circuit to increase the duty ratio as the detected voltage is reduced from the fully charged state.
(5) The electric tool according to (4), wherein

the duty ratio is set every time when a rotation switch of the motor is turned on to activate the motor, and

the set duty ratio is maintained until the rotation switch is released.
(6) The electric tool according to any one of (1) to (5), wherein the duty ratio is calculated using operational expressions based on the detected temperature and the detected voltage.
(7) The electric tool according to any one of (1) to (5), wherein

the relationship between the detected temperature and the detected voltage and the duty ratio are stored in advance in the controller as a table which is divided into multiple sections and,

the controller determines the duty ratio by referring to the table when a rotation switch of the motor is turned on.
(8) The electric tool according to any one of (1) to (7), wherein

the electric tool has a low-load operating mode and a high-load operating mode,

the controller drives the brushless motor at a fixed duty ratio regardless of the detected voltage during the low-load operating mode, and

the controller adjusts the duty ratio based on the detected temperature and the detected voltage during the high-load operating mode.
(9) An electric tool comprising:

a motor;

a battery configured to supply drive power to the motor;

a voltage detector configured to detect a voltage of the battery; and

an operating unit configured to reduce a duty ratio of PWM control signal supplied to the motor when the voltage of the battery is increased.
(10) The electric tool according to (9) further comprising a temperature detector configured to detect a temperature of the motor,

wherein the operating unit increases the duty ratio of PWM control signal supplied to the motor when the temperature of the motor is dropped.
(11) An electric tool comprising:

a motor;

a removable battery configured to supply drive power to the motor; and

an operating unit configured to reduce a duty ratio of PWM control signal supplied to the motor to a value less than 100% immediately after the battery is mounted to the electric tool.
(12) The electric tool according to (11) further comprising a voltage detector configured to detect a voltage of the battery,

wherein the operating unit reduces the duty ratio of PWM control signal supplied to the motor when the voltage detected by the voltage detector is increased.

According to the aspect described in (1), the duty ratio of PWM drive signal for driving the semiconductor switching elements is determined from the relationship between the temperature detected by the temperature detector and the voltage detected by the voltage detector. With this configuration, it is possible to suppress excessive temperature rise of a part susceptible to thermal damage. As a result, it is possible to improve reliability and lifetime of the electric tool, in addition to enabling a continuous operation of the electric tool while exchanging a plurality of batteries.

According to the aspect described in (2), the temperature detector is mounted on the circuit board which is provided at the end side of the brushless motor. With this configuration, it is possible to directly or indirectly measure the temperature of the semiconductor switching elements or the motor by the temperature detector.

According to the aspect described in (3), the controller is controlled to decrease the duty ratio of PWM drive signal when the detected voltage is high and to increase the duty ratio of PWM drive signal as the detected voltage is dropped. With this configuration, decrease in the rotation number of the motor can be suppressed to the minimum when the voltage of the battery is dropped and thus it is possible to realize a tightening work with good efficiency.

According to the aspect described in (4), the controller is controlled to restrict the upper limit of the duty ratio to the predetermined value less than 100% immediately after the battery in a state of fully charged is mounted. With this configuration, it is possible to prevent excessive temperature rise of the motor or the switching element due to a high-voltage drive immediately after the battery pack is exchanged.

According to the aspect described in (5), the upper limit of the duty ratio is set when a trigger switch is turned on and is constantly held until the trigger switch is turned off. With this configuration, it is possible to prevent an unstable control such as variation of the duty ratio during one tightening work and therefore the tightening work can be stably performed without giving an uncomfortable feeling to an operator.

According to the aspect described in (6), since the duty ratio is calculated using operational expressions based on the detected temperature and the detected voltage, change in the duty ratio is gradual. With this configuration, it is possible to prevent occurrence of an unnatural situation where switching of the motor output is suddenly done, even if a plurality of bolt-tightening works is performed. Accordingly, a smooth motor control can be realized.

According to the aspect described in (7), since the duty ratio is stored in advance as a table which is divided into multiple sections, it is possible to rapidly determine the duty ratio by referring to the table when the rotation switch is turned on.

According to the aspect described in (8), the electric tool has the low-load operating mode and the high-load operating mode as a control mode of the motor and the controller adjusts the duty ratio based on the detected temperature and the detected voltage only when the motor is in the high-load operating mode. With this configuration, it is possible to reduce the duty ratio by a fine control in accordance with the control mode. Further, the duty ratio is constantly fixed during a low-load work in which the adjustment of the duty ratio is not required. Accordingly, it is possible to activate the motor quickly.

According to the aspect described in (9), overheating of the motor can be prevented by daringly dropping the duty ratio of PWM drive signal supplied to the motor in anticipation of increase in the power supplied to the motor when it is detected that the voltage of the battery becomes high. Accordingly, it is possible to continuously perform a high-load work by exchanging or charging the battery.

According to the aspect described in (10), excessive decrease in the output of the motor can be prevented by increasing the duty ratio of PWM drive signal supplied to the motor in anticipation of the fact that the motor is not overheated for a while when the temperature of the motor is dropped, even if the voltage of the battery becomes high. Accordingly, it is possible to continuously perform a high-load work by exchanging or charging the battery.

According to the aspect described in (11), overheating of the motor can be prevented by daringly dropping the duty ratio of PWM drive signal supplied to the motor in anticipation of increase in the power supplied to the motor when it is detected that the battery is exchanged or charged. Accordingly, it is possible to continuously perform a high-load work by exchanging or charging the battery.

According to the aspect described in (12), the voltage detector can detect that the battery is exchanged or charged.

The foregoing and other objects and features of the present invention will be apparent from the detailed description below and accompanying drawings.

### BRIEF DESCRIPTION OF THE DRAWINGS

FIG. 1 is a cross-sectional view showing an internal structure of an impact driver according to an illustrative embodiment of the present invention.

FIG. 2A is a rear view of an inverter circuit board 4 seen from the rear side of the impact driver 1.

FIG. 2B is a side view of the inverter circuit board 4 as seen from the side of the impact driver.

FIG. 3 is a block diagram showing a circuit configuration of a drive control system of a motor 3 according to the illustrative embodiment of the present invention.

FIG. 4 is a view showing a relationship among a motor temperature, a battery voltage and a duty ratio of PWM drive signal in the present embodiment.

FIG. 5 is a flowchart showing a setting procedure of a duty ratio for motor control when performing a tightening work using the impact driver 1 of the first embodiment.

FIG. 6 is a matrix table showing a relationship among a battery voltage, a motor temperature and the duty ratio in a second embodiment of the present invention.

FIG. 7 is a flowchart showing a setting procedure of a duty ratio for motor control when performing a tightening work using the impact driver 1 of the second embodiment.

FIG. 8 is another example of a matrix table showing a relationship among a battery voltage, a motor temperature and the duty ratio in the second embodiment of the present invention.

### DESCRIPTION OF EXEMPLARY EMBODIMENTS

### Embodiment 1

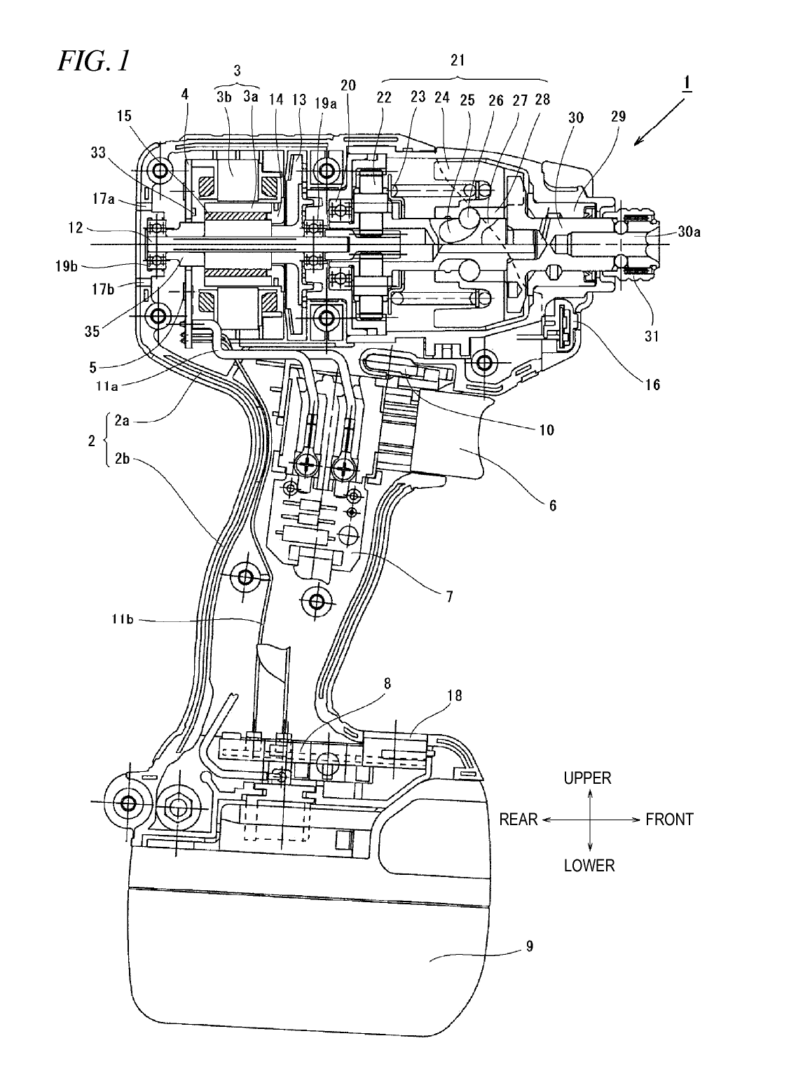

Hereinafter, exemplary embodiments of the present invention will be described with reference to the accompanying drawings. Further, as used herein, a front-rear direction and an upper-lower direction are referred to the directions indicated by arrows of FIG. 1.

FIG. 1 is a view showing an internal structure of an impact driver 1 as an example of an electric tool according to the exemplary embodiments. The impact driver 1 is powered by a rechargeable battery 9 and uses a motor 3 as a driving source to drive a rotary striking mechanism 21. The impact driver 1 applies a rotating force and a striking force to an anvil 30 which is an output shaft. The electric tool 1 intermittently transmits a rotational striking force to a tip tool (not shown) such as a driver bit to fasten a screw or a bolt. Here, the tip tool is held on an mounting hole 30a of a sleeve 31.

The brushless DC type motor 3 is accommodated in a cylindrical main body 2a of a housing 2 which is substantially T-shaped, as seen from the side. A rotating shaft 12 of the motor 3 is rotatably held by a bearing 19a and a bearing 19b. The bearing 19a is provided near the center of the main body 2a of the housing 2 and the bearing 19b is provided on a rear end side thereof. A rotor fan 13 is provided in front of the motor 3. The rotor fan 3 is mounted coaxial with the rotating shaft 12 and rotates in synchronous with the motor 3. An inverter circuit board 4 for driving the motor 3 is arranged in the rear of the motor 3. A thermistor is mounted on the circuit board to detect temperature of a switching element or the circuit board. Air flow generated by the rotor fan 13 is introduced into the housing 2 through air inlets 17a, 17b and a slot (not shown) formed on a portion of the housing around the inverter circuit board 4. And then, the air flow mainly flows to pass through between a rotor 3a and a stator 3b. In addition, the air flow is sucked form the rear of the rotor fan 13 and flows in the radial direction of the rotor fan 13. And, the air flow is discharged to the outside of the housing 2 through a slot (not shown) formed on a portion of the housing around the rotor fan 13. The inverter circuit board 4 is a double-sided board having a circular shape substantially equal to an outer shape of the motor 3. A plurality of switching elements 5 such as FETs or a position detection element 33 such as hall IC is mounted on the inverter circuit board.

Between the rotor 3a and the bearing 19a, a sleeve 14 and the rotor fan 13 are mounted coaxially with the rotating shaft 12. The rotor 3a forms a magnetic path formed by a magnet 15. For example, the rotor 3a is configured by laminating four plate-shaped thin metal sheets which are formed with slot. The sleeve 14 is a connection member to allow the rotor fan 13 and the rotor 3a to rotate without idling and made from plastic, for example. As necessary, a balance correcting groove (not shown) is formed at an outer periphery of the sleeve 14. The rotor fan 13 is integrally formed by plastic molding, for example. The rotor fan is a so-called centrifugal fan which sucks air from an inner peripheral side at the rear and discharges the air radially outwardly at the front side. The rotor fan includes a plurality of blades extending radially from the periphery of a through-hole which the rotating shaft 12 passes through.

A plastic spacer 35 is provided between the rotor 3a and the bearing 19b. The spacer 35 has an approximately cylindrical shape and sets a gap between the bearing 19b and the rotor 3a. This gap is intended to arrange the inverter circuit board 4 (see FIG. 1) coaxially and required to form a space which is necessary as a flow path of air flow to cool the switching elements 5.

A handle part 2b extends substantially at a right angle from and integrally with the main body 2a of the housing 2. A trigger switch 6 is provided on an upper side region of the handle part 2b. A switch board 7 is provided below the trigger switch 6. A control circuit board 8 is accommodated in a lower side region of the handle part 2b. The control circuit board 8 has a function to control the speed of the motor 3 by an operation of pulling the trigger switch 6. The control circuit board 8 is electrically connected to the battery 9 and the trigger switch 6. The control circuit board 8 is connected to the inverter circuit board 4 via a signal line 11b. Below the handle part 2b, the battery 9 such as a nickel-cadmium battery, a lithium-ion battery is removably mounted. The battery 9 is packed with a plurality of secondary batteries such as lithium ion battery, for example. When charging the battery 9, the battery 9 is removed from the impact driver 1 and mounted on a dedicated charger (not shown).

The rotary striking mechanism 21 includes a planetary gear reduction mechanism 22, a spindle 27 and a hammer 24. A rear end of the rotary striking mechanism is held by a bearing 20 and a front end thereof is held by a metal 29. As the trigger switch 6 is pulled and thus the motor 3 is activated, the motor 3 starts to rotate in a direction set by a forward/reverse switching lever 10. The rotating force of the motor 3 is decelerated by the planetary gear reduction mechanism 22 and transmitted to the spindle 27. Accordingly, the spindle 27 is rotationally driven in a predetermined speed. Here, the spindle 27 and the hammer 24 are connected to each other by a cam mechanism. The cam mechanism includes a V-shaped spindle cam groove 25 formed on an outer peripheral surface of the spindle 27, a hammer cam groove 28 formed on an inner peripheral surface of the hammer 24 and balls 26 engaged with these cam grooves 25, 28.

The hammer 24 is normally urged forward by a spring 23. When stationary, the hammer 24 is located at a position spaced away from an end surface of the anvil 30 by engagement of the balls 26 and the cam grooves 25, 28. Convex portions (not shown) are symmetrically formed, respectively in two locations on the rotation planes of the hammer 24 and the anvil 30 which are opposed to each other. As the spindle 27 is rotationally driven, the rotation of the spindle is transmitted to the hammer 24 via the cam mechanism. At this time, since the convex portion of the hammer 24 is engaged with the convex portion of the anvil 30 when the hammer 24 does not make a half turn, the anvil 30 is rotated. However, in a case where the relative rotation occurs between the spindle 27 and the hammer 24 by an engagement reaction force at that time, the hammer 24 starts to retreat toward the motor 3 while compressing the spring 23 along the spindle cam groove 25 of the cam mechanism.

As the convex portion of the hammer 24 gets beyond the convex portion of the anvil 30 by the retreating movement of the hammer 24 and thus engagement between these convex portions is released, the hammer 24 is rapidly accelerated in a rotation direction and also in a forward direction by the action of the cam mechanism and the elastic energy accumulated in the spring 23, in addition to the rotation force of the spindle 27. Further, the hammer 24 is moved in the forward direction by an urging force of the spring 23 and the convex portion of the hammer 24 is again engaged with the convex portion of the anvil 30. Thereby, the hammer activates to rotate integrally with the anvil. At this time, since a powerful rotational striking force is applied to the anvil 30, the rotational striking force is transmitted to a screw via a tip tool (not shown) mounted on the mounting hole 30a of the anvil 30.

Thereafter, the same operation is repeatedly performed and thus the rotational striking force is intermittently and repeatedly transmitted from the tip tool to the screw. Thereby, the screw can be screwed into a member to be fastened (not shown) such as wood, for example.

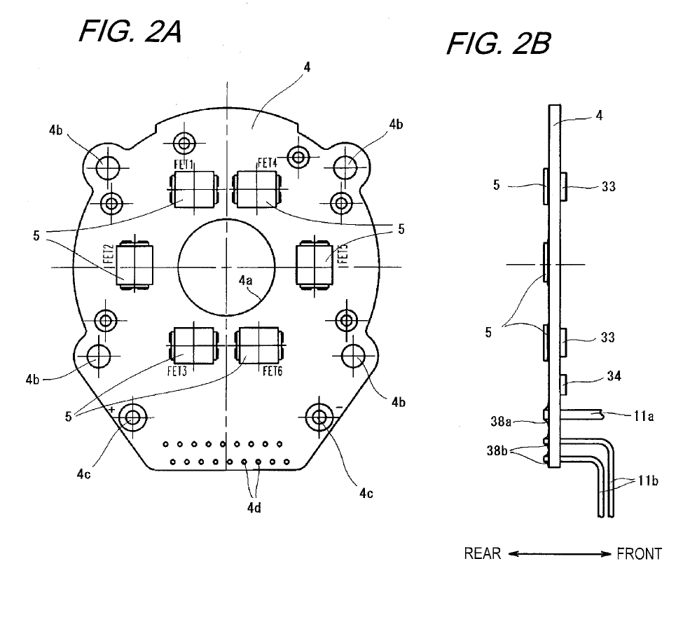

Next, the inverter circuit board 4 of the present embodiment will be described with reference to FIG. 2. FIG. 2A is a rear view of an inverter circuit board 4 seen from the rear side of the impact driver 1. FIG. 2B is a side view of the inverter circuit board 4 as seen from the side of the impact driver. The inverter circuit board 4 is configured by a glass epoxy (which is obtained by curing a glass fiber by epoxy resin), for example and has an approximately circular shape substantially equal to an outer shape of the motor 3. The inverter circuit board 4 is formed at its center with a hole 4a through which the spacer 35 passes. Four screw holes 4b are formed around the inverter circuit board 4 and the inverter circuit board 4 is fixed to the stator 3b by screws passing through the screw holes 4b. Six switching elements 5 are mounted to the inverter circuit board 4 to surround the holes 4a. Although a thin FET is used as the switching element 5 in the present embodiment, a normal-sized FET may be used.

Since the switching element 5 has a very thin thickness, the switching element 5 is mounted on the inverter circuit board 4 by SMT (Surface Mount Technology) in a state where the switching element is laid down on the board. Meanwhile, although not shown, it is preferable to coat a resin such as silicon to surround the entire six switching elements 5 of the inverter circuit board 4. The inverter circuit board 4 is a double-sided board. Electronic elements such as three position detection elements 33 (only two shown in FIG. 2B) and the thermistor 34, etc., are mounted on a front surface of the inverter circuit board 4. The inverter circuit board 4 is shaped to protrude slightly below a circle the same shape as the motor 3. A plurality of through-holes 4d are formed at the protruded portion. Signal lines 11b pass through the through-holes 4d from the front side and then are fixed to the rear side by soldering 38b. Similarly, a power line 11a passes through a through-hole 4c of the inverter circuit board 4 from the front side and then is fixed to the rear side by soldering 38a. Alternatively, the signal lines 11b and the power line 11a may be fixed to the inverter circuit board 4 via a connector which is fixed to the board.

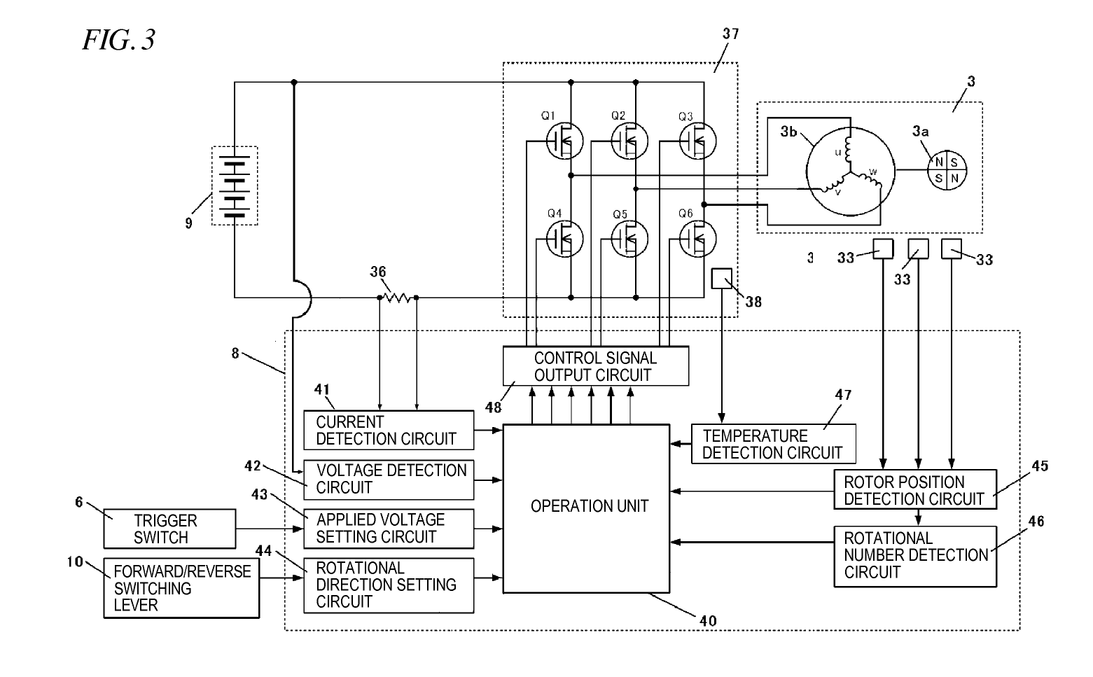

Next, a configuration and operation of a drive control system of the motor 3 will be described with reference to FIG. 3. FIG. 3 is a block diagram illustrating a configuration of the drive control system of the motor. In the present embodiment, the motor 3 is composed of three-phase brushless DC motor.

The motor 3 is a so-called inner rotor type and includes the rotor 3a, three position detection elements 33 and the stator 3b. The rotor 3a is configured by embedding the magnet 15 (permanent magnet) having a pair of N-pole and S-pole. The position detection elements 33 are arranged at an angle of 60° to detect the rotation position of the rotor 3a. The stator 3b is composed of star-connected three-phase windings U, V W which are controlled at current energization interval of 120° electrical angle on the basis of position detection signals from the position detection elements 33. In the present embodiment, although the position detection of the rotor 3a is performed in an electromagnetic coupling manner using the position detection elements 33 such as Hall IC, a sensorless type may be employed in which the position of the rotor 3a is detected by extracting an induced electromotive force (back electromotive force) of the armature winding as logic signals via a filter.

An inverter circuit 37 is configured by six FETs (hereinafter, simply referred to as “transistor”) Q1 to Q6 which are connected in three-phase bridge type and a flywheel diode (not shown). The inverter circuit 37 is mounted on the inverter circuit board 4. A temperature detection element (thermistor) 38 is fixed to a position near the transistor on the inverter circuit board 4. Each gate of the six transistors Q1 to Q6 connected in the bridge type is connected to a control signal output circuit 48. Further, a source or drain of the six transistors Q1 to Q6 is connected to the star-connected armature windings U, V W. Thereby, the six transistors Q1 to Q6 perform a switching operation by a switching element driving signal which is outputted from the control signal output circuit 48. The six transistors Q1 to Q6 supply power to the armature windings U, V, W by using DC voltage of the battery 9 applied to the inverter circuit 37 as the three-phase (U phase, V phase, W phase) AC voltages Vu, Vv, Vw.

An operation part 40, a current detection circuit 41, a voltage detection circuit 42, an applied voltage setting circuit 43, a rotation direction setting circuit 44, a rotor position detection circuit 45, a rotation number detection circuit 46, a temperature detection circuit 47 and the control signal output circuit 48 are mounted on the control circuit board 8. Although not shown, the operation part 40 is configured by a microcomputer which includes a CPU for outputting a drive signal based on a processing program and data, a ROM for storing a program or data corresponding to a flowchart (which will be described later), a RAM for temporarily storing data and a timer, etc. The current detection circuit 41 is a current detector for detecting current flowing through the motor 3 and the detected current is inputted to the operation part 40. The voltage detection circuit 42 is a circuit for detecting battery voltage of the battery 9 and the detected voltage is inputted to the operation part 40.

The applied voltage setting circuit 43 is a circuit for setting an applied voltage of the motor 3, that is, a duty ratio of PWM signal, in response to a movement stroke of the trigger switch 6. The rotation direction setting circuit 44 is a circuit for setting the rotation direction of the motor 3 by detecting an operation of forward rotation or reverse rotation by the forward/reverse switching lever 10 of the motor. The rotor position detection circuit 45 is a circuit for detecting positional relationship between the rotor 3a and the armature windings U, V W of the stator 3b based on output signals of the three position detection elements 33. The rotation number detection circuit 46 is a circuit for detecting the rotation number of the motor based on the number of the detection signals from the rotor position detection circuit 45 which is counted in unit time. The control signal output circuit 48 supplies PWM signal to the transistors Q1 to Q6 based on the output from the operation part 40. The power supplied to each of the armature windings U, V W is adjusted by controlling a pulse width of the PWM signal and thus the rotation number of the motor 3 in the set rotation direction can be controlled.

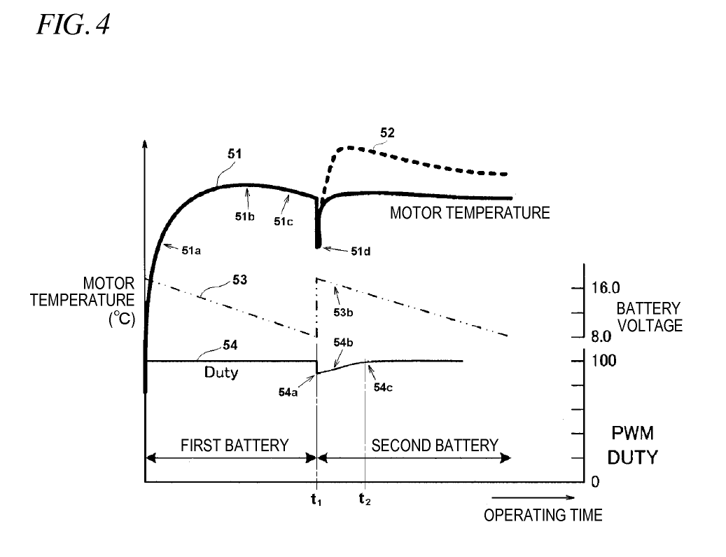

Next, a relationship among the motor temperature, the battery voltage and the duty ratio of PWM drive signal in the present embodiment will be described with reference to FIG. 4. The present embodiment relates to a control in a case where high-load work using the impact driver 1, for example, bolting work having tightening torque more than 100 N·m is continuously performed. First battery 9 is mounted on the impact driver 1 at time 0 and then the bolting work is continuously performed. Then, the number of the bolts which are continuously tightened is increased and thus the temperature of the motor 3 rises. And then, the motor temperature 51 rises rapidly as indicated by arrow 51a of FIG. 4. Furthermore, when a plurality of the bolting works is continuously performed, the raised motor temperature 51 reaches a peak at a point of arrow 51b and then is gradually decreased as indicated by arrow 51c. The reason for such a decrease is because a battery voltage 53 is gradually decreased as indicated by two-dot chain line and thus amount of heat generation of the motor is decreased at that time. Here, the first batter 9 is over-discharged at time t₁ and removed and then second battery 9 is mounted. At this time, since it takes some time to replace the first battery with the second battery, the motor temperature 51 is greatly decreased temporarily as indicated by arrow 51d due to the time-lapse.

The second battery 9 is mounted and then the bolting work is continuously performed again. In this case, when the bolting work is performed in a state where the duty ratio of the PWM drive signal is fixed at 100% as in the first battery, similarly to the conventional art, heat generation is further increased from the high temperature state of the motor 3 and therefore temperature curve becomes as indicated by dotted line 52. In the state as indicated by the dotted line 52, a semiconductor element such as a switching element which is mounted on the motor 3 or the inverter circuit board 4 is also subjected to thermal damage. Consequently, the service life of the semiconductor element is shortened or the semiconductor element itself is broken in the worst case. Accordingly, in the present embodiment, the operation part 40 monitors the motor temperature and the battery voltage. And, the operation part 40 is controlled to decrease the duty ratio of the PWM drive signal when it is determined that the heat generation of the motor exceeds a reference value (for example, the heat generation reaches a temperature higher than the arrow 51b) based on the relationship between the motor temperature and the battery voltage. In this way, the heat generation of the motor 3 or the heat generation of the switching element is suppressed. Such a state is represented by a duty ratio 54 and the duty ratio is decreased as indicated by arrow 54a immediately after the battery 9 is exchanged. Thereafter, as the battery voltage 53 is decreased as indicated by arrow 53b, a control is performed so that the duty ratio 54 is increased. At a point when worry of temperature rise of the motor 3 is no longer, that is, at arrow 54c, the duty ratio of the PWM drive signal becomes a full state.

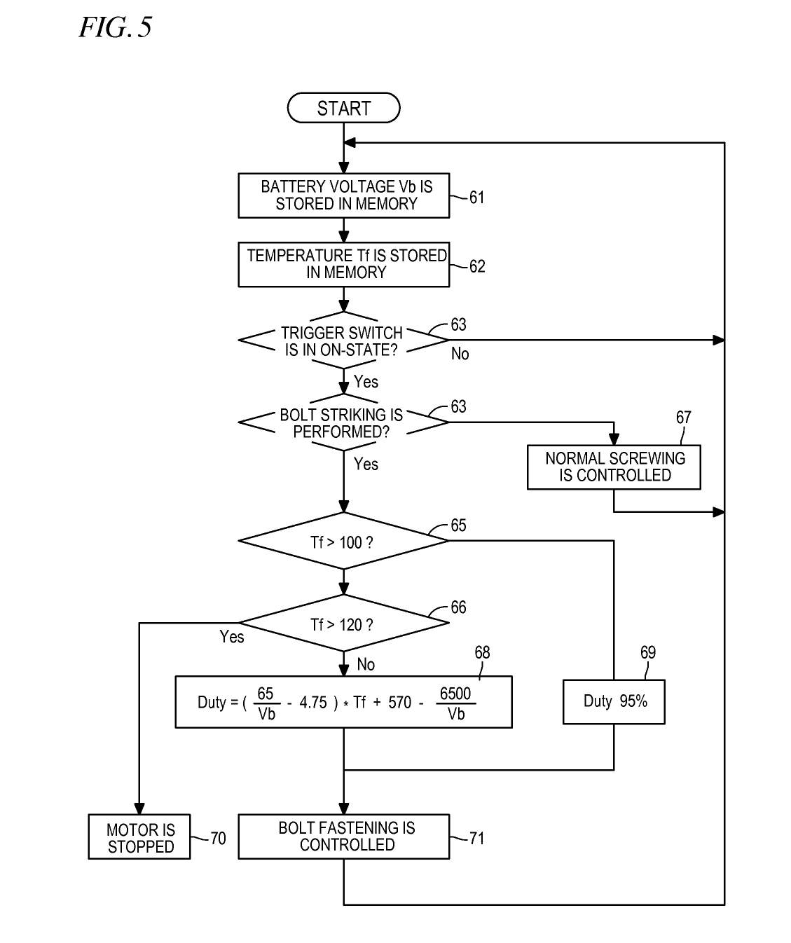

Next, a setting procedure of a duty ratio for motor control when performing a tightening work using the impact driver 1 is described with reference to the flowchart of FIG. 5. The control procedure shown in FIG. 5 is realized in a software manner by causing the operation part 40 including a microcomputer to execute a computer program, for example. First, when the battery 9 is mounted to the impact driver 1, the operation part 40 causes the voltage detection circuit 42 to detect the battery voltage Vb and the detected battery voltage Vb is stored in a memory (RAM) (not shown) which is included in the operation part 40 (Step 61). Next, the temperature detection circuit 47 detects a temperature Tf using a temperature sensor 38 and the detected temperature Tf is stored in the memory of the operation part 40 (Step 62).

Then, the operation part 40 determines whether the trigger switch 6 is pulled by an operator and turned-on or not. If the trigger switch is not pulled, the procedure returns to Step 61 (Step 63). When it is detected at Step 63 that the trigger switch 6 is pulled, the operation part determines whether a bolt striking is performed or not (Step 64). In a case of the impact driver 1, such a determination can be determined by a mode setting situation by a dial, etc. For example, such a determination can be determined by whether any one of a driver drill mode such as a typical vis tightening work and an impact mode when performing a bolting or high load tightening work is set. When it is determined at Step 64 that the bolt striking is not performed, that is, that a work under a relatively light load is performed, a typical screw tightening control is performed. As one tightening work is completed, the procedure returns to Step 61 (Step 67). Since a detailed control flow during Step 67 is known, a detailed description thereof is omitted. When it is determined at Step 64 that the bolt striking is performed, it is determined whether the temperature Tf stored in the memory is less than 100° C. or not (Step 65). When it is determined that the temperature Tf is less than 100° C., the duty ratio is set to 95% which is a fixed value and a typical bolting control is performed (Steps 69, 71). Meanwhile, since there is no case that the temperature of the motor part exceeds 100° C. when the bolting work is intermittently performed, it is general that an upper limit of the duty ratio is mostly set to 95% (this value can be set arbitrarily). Since a detailed control flow during Step 71 is known, a detailed description thereof is omitted.

Next, the operation part 40 determines whether the temperature Tf stored in the memory is greater than 120° C. or not (Step 66). When it is determined that the temperature Tf is greater than 120° C., this means that the motor 3 or the switching element is in an abnormal overheating state. Accordingly, activation of the motor is not allowed and the motor 3 is in a stopped stat (Step 70). When it is determined at Step 66 that the temperature Tf stored in the memory is not more than 120° C., the duty ratio is calculated and obtained by following mathematic formula 1 (Step 68).

$$Duty = ( \frac{65}{Vb} - 4.75 ) * Tf + 570 - \frac{6500}{Vb} \qquad [ Mathematic Formula 1 ]$$

Here, Vb: battery Voltage (V) and Tf: motor temperature (° C.)

By using the mathematic formula 1 in this way, it is possible to calculate the duty ratio in consideration of the motor temperature or the battery voltage. In this arithmetic expression, the motor temperature Tf (° C.) between 100° C. and 120° C. becomes a linear approximation. The operation part 40 performs a calculation using the mathematic formula 1, sets the calculated duty ratio (%) as an upper limit and performs the typical bolting control (Step 71).

As described above, according to the embodiment of the present invention, it is possible to adjust on-time of the PWM control which performs the speed control of the motor, based on the battery voltage and the motor temperature (or switching element temperature). Thereby, it is possible to prevent excessive temperature rise of the motor or the switching element. Particularly, it is possible to perform a work in a stable manner, even in a high-load work performing continuous bolting works over 100 times using a plurality of batteries 9. Further, the duty ratio can be adjusted by the arithmetic expression of the mathematic formula 1. Therefore, the duty ratio can be adjusted continuously gradually rather than incremental changes and thus an operator can perform a work smoothly without recognizing the transition of the control.

### Second Embodiment

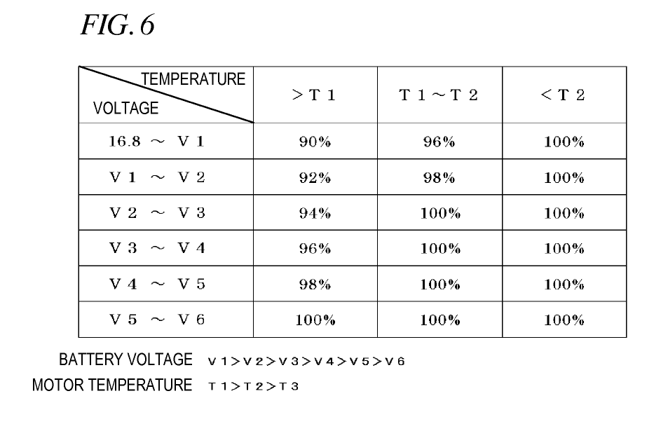

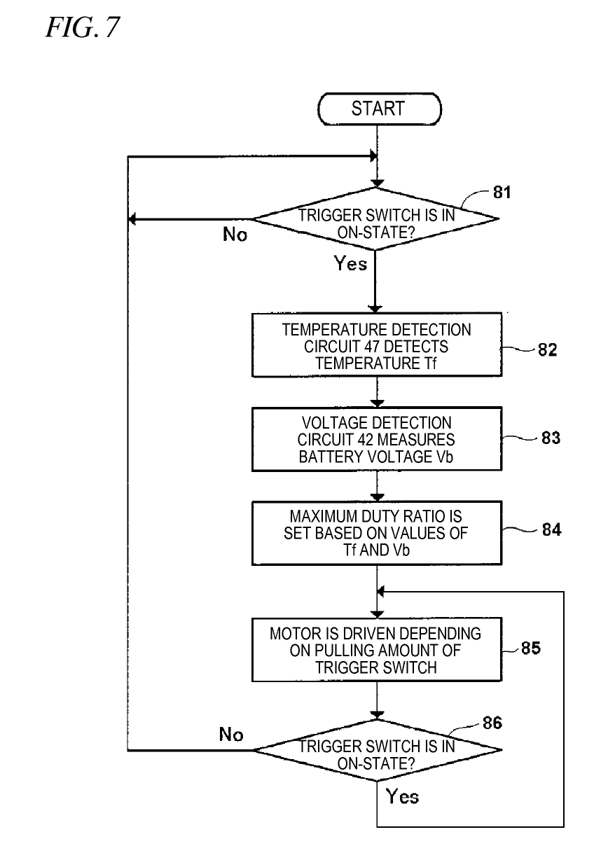

Next, a second embodiment of the present invention will be described with reference to FIGS. 6 and 7. In the first embodiment, the duty ratio of the PWM control which performs the speed control of the motor is calculated by the calculation, based on the battery voltage or the motor temperature immediately before the trigger is pulled. In the second embodiment, calculation results of the first embodiment are grouped to some extent and stored in ROM (not shown) which is included in the operation part 40, or the like. In this way, the setting process of the duty ratio is shortened. FIG. 6 is a matrix table showing a relationship among the battery voltage, the motor temperature and the duty ratio. Here, the battery voltage is divided into six steps and the motor temperature is divided into three steps. And, optimal duty ratios are stored on the basis of combination of the battery voltages and motor temperatures. Here, it is preferable that the stored duty ratios are optimal values obtained by experiment or measurement or values calculated by calculation. Further, although the battery voltage is divided into six steps and the motor temperature is divided into three steps in the present embodiment, the number of steps in such a division is arbitrary. In the present embodiment, T1 is about 120° C., T2 is about 100° C. and V6 is about 8.0 V.

In a state of FIG. 6, when the battery 9 is close to a fully charged state (for example, in a range of V1 to 16.8V) and also the motor temperature is in the highest state (>T1), the upper limit of the duty ratio is set to 90% which is a slightly lower value. By setting in this way, it is possible to avoid an abnormal overheating state of the motor 3, even if an operator fully pulls the trigger switch 6 to rotate the motor. Meanwhile, in a case of the impact driver 1 using a variable switch as the trigger switch 6, the duty ratio of 90% in the table of FIG. 6 means that an upper limit of the duty ratio set when fully pulling the trigger switch 6 is 90%. Here, in a case where capacity of the battery 9 is decreased and thus the battery voltage is dropped to a range of V6 to V5, amount of heat generation is small even when the motor 3 is fully rotated and thus overheating of the motor 3 or the like, is suppressed. Accordingly, the upper limit of the duty ratio is set to 100%.

FIG. 7 is a flowchart showing a setting procedure of a duty ratio for motor control when performing a tightening work using the impact driver 1 of the second embodiment. First, when the battery 9 is mounted to the impact driver 1, the operation part 40 determines whether the trigger switch 6 is pulled or not (Step 81). When it is determined that the trigger switch 6 is not pulled, the procedure is in a standby state until the trigger switch is pulled. As the trigger switch 6 is pulled, the temperature Tf is detected using the output of the temperature detection circuit 47 (Step 82). And then, the operation part 40 detects the battery voltage Vb from the output of the voltage detection circuit 42 (Step 83). Next, the operation part 40 sets a maximum duty ratio of the PWM control to perform the speed control of the motor 3 from the matrix shown in FIG. 6 using the obtained temperature Tf and the battery voltage Vb (Step 84). Since the setting of the duty ratio can be performed just by reading out data which is stored in advance in a storage device (not shown) of the operation part 40, the temperature Tf and the battery voltage Vb are detected at a timing when the trigger switch 6 is pulled, in the second embodiment. Meanwhile, in the first embodiment, the detection of the temperature Tf and the battery voltage Vb is completed before the trigger switch 6 is pulled. Also in the second embodiment, the detection of the temperature Tf and the battery voltage Vb can be performed at an arbitrary timing (immediately before, at the same time or immediately after) when the trigger switch 6 is pulled.

Next, the operation part 40 performs the rotation control of the motor 3 depending on the pulled amount of the trigger switch 6 (Step 85) and the control of Step 85 and Step 86 is repeated until the trigger switch 6 is released (Step 86). If the trigger switch 6 is returned at Step 86, the procedure returns Step 81. As described above, in the second embodiment, it is possible to adjust the duty ratio of the PWM control based on the battery voltage and the motor temperature (or switching element temperature). Thereby, it is possible to prevent excessive temperature rise of the motor or the switching element when performing high-load works in a continuous manner. Further, by controlling the duty ratio of the PWM control in conjunction with the temperature detected by the temperature detector, the duty ratio of the PWM control can gently changed. Thereby, the rotation number of the motor can be smoothly migrated.

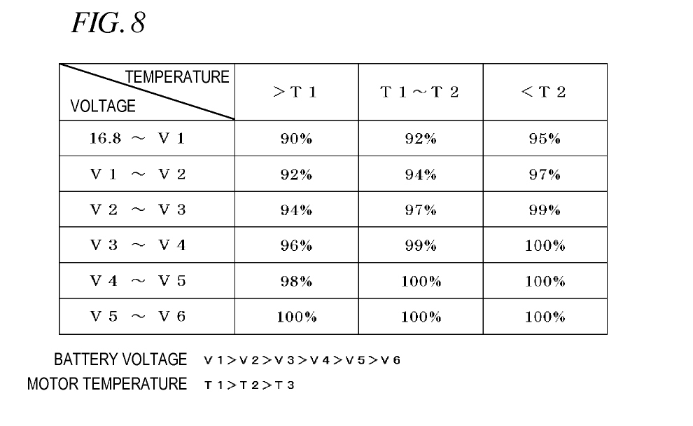

Meanwhile, the matrix table of FIG. 6 showing a relationship among the battery voltage, the motor temperature and the duty ratio may be properly set depending on the type of tool which performs work using an electric motor. FIG. 8 is another example of a matrix table showing a relationship among the battery voltage, the motor temperature and the duty ratio. Unlike the table of FIG. 6, in FIG. 8, the maximum value of the duty ratio is set not to 100% but to about 95% to 99% in a range of V1 to 16.8, V2 to V1 and V3 to V2, even when the temperature is sufficient low (<T2). This is an effective adjustment method in a case where there is a risk that tightening torque is excessively increased due to high battery voltage and thus a bolt to be tightened is damaged. In a method to limit the maximum duty ratio when the battery is at a high-voltage state, the duty ratio may be further decreased and thus reduced by 10% at maximum. The duty ratio may be set by setting a single or multiple tables corresponding to the control mode of the electric tool in this way and using the table according to the control mode.

Hereinabove, although the present invention has been described with reference to the illustrative embodiments, the present invention is not limited to the above-described embodiments, but can be variously modified without departing from the gist of the present invention. For example, although the impact driver has been described as an example of the electric tool in the above-described embodiment, the present invention is not limited to the impact driver, but can be similarly applied to other electric tools such as an electric working machine or a power tool which uses a motor as a driving source.

1. An electric tool for driving a tip tool, the electric tool comprising:
a removable battery;
a brushless motor configured to generate a driving force for driving the tip tool;
an inverter circuit configured to supply drive power from the removable battery to the brushless motor using a plurality of semiconductor switching elements;
a controller configured to control the inverter circuit to control rotation of the brushless motor;
a temperature detector configured to detect a temperature of the brushless motor or the semiconductor switching elements; and
a voltage detector configured to detect a voltage of the battery,
wherein the brushless motor is driven such that a duty ratio of PWM drive signal for driving the semiconductor switching elements is determined based on relationship between the temperature detected by the temperature detector and the voltage detected by the voltage detector.

2. The electric tool according to claim 1, wherein
the inverter circuit includes a circuit board on which the semiconductor switching elements are mounted,
the circuit board is fixed to an end side of the brushless motor and,
the temperature detector is mounted on the circuit board.

3. The electric tool according to claim 1, wherein the controller controls the inverter circuit to decrease the duty ratio of PWM drive signal when the detected voltage is high and controls the inverter circuit to increase the duty ratio of PWM drive signal as the detected voltage is dropped.

4. The electric tool according to claim 3, wherein the controller controls the inverter circuit to restrict an upper limit of the duty ratio to a predetermined value less than 100% immediately after the battery in a state of fully charged is mounted and controls the inverter circuit to increase the duty ratio as the detected voltage is reduced from the fully charged state.

5. The electric tool according to claim 4, wherein
the duty ratio is set every time when a rotation switch of the motor is turned on to activate the motor, and
the set duty ratio is maintained until the rotation switch is released.

6. The electric tool according to claim 1, wherein the duty ratio is calculated using operational expressions based on the detected temperature and the detected voltage.

7. The electric tool according to claim 1, wherein
the relationship between the detected temperature and the detected voltage and the duty ratio are stored in advance in the controller as a table which is divided into multiple sections and,
the controller determines the duty ratio by referring to the table when a rotation switch of the motor is turned on.

8. The electric tool according to claim 1, wherein
the electric tool has a low-load operating mode and a high-load operating mode,
the controller drives the brushless motor at a fixed duty ratio regardless of the detected voltage during the low-load operating mode, and
the controller adjusts the duty ratio based on the detected temperature and the detected voltage during the high-load operating mode.

9. An electric tool comprising:
a motor;
a battery configured to supply drive power to the motor;
a voltage detector configured to detect a voltage of the battery; and
an operating unit configured to reduce a duty ratio of PWM control signal supplied to the motor when the voltage of the battery is increased.

10. The electric tool according to claim 9 further comprising a temperature detector configured to detect a temperature of the motor,
wherein the operating unit increases the duty ratio of PWM control signal supplied to the motor when the temperature of the motor is dropped.

11. An electric tool comprising:
a motor;
a removable battery configured to supply drive power to the motor; and
an operating unit configured to reduce a duty ratio of PWM control signal supplied to the motor to a value less than 100% immediately after the battery is mounted to the electric tool.

12. The electric tool according to claim 11 further comprising a voltage detector configured to detect a voltage of the battery,
wherein the operating unit reduces the duty ratio of PWM control signal supplied to the motor when the voltage detected by the voltage detector is increased.
